(19) United States
(12) Patent Application Publication
(10) Pub. No.: US 2007/0139844 A1
(43) Pub. Date: Jun. 21, 2007

(54) Power safety circuit for small appliances

(76) Inventors: Leonard I. Horey, Fort Lauderdale, FL (US); Gabriel S. Kohn, Boca Raton, FL (US)

Correspondence Address: Lawrence J. Shurupoff;Sunbeam Products, Inc., 2381 Executive Center Drive, Boca Raton, FL, 33431, US

(21) Appl. No.: 11/305,665

(22) Filed: Dec. 16, 2005

(51) Int. Cl. H02H 5/04

(52) U.S. Cl. 361/104

(57) ABSTRACT

A circuit is provided for powering a small electrical appliance load. In one embodiment the circuit includes a power output control device such as a triac to supply power to the load. A thermal fuse is placed in series with the triac. A resistor is placed in thermal proximity to the thermal fuse. A switching device such as a transistor is provided to turn on the resistor. A microcomputer controller monitors a short fault condition of the triac. The microcomputer controller turns on the transistor upon detecting a short fault condition in the triac.

### FIELD OF THE INVENTION

The present invention is directed to power supply circuits for powering electrical appliances.

### BACKGROUND OF THE INVENTION

By using microcomputers to control common household electrical appliances, manufacturers have been able to provide diagnostics and safety features on both the products and their control electronics. A microcomputer monitors various signals representative of operating conditions and determines whether the product is operating as intended or whether some fault has occurred. The microcomputer or microprocessor then warns the user of the fault condition and/or safely shuts down the product.

This ability to detect fault conditions enhances the safety of the product. However, there are some cases where the microcomputer or microprocessor detects a fault, but is unable to shut down the product. An example of this is when the microcomputer detects that a power output control device (sometimes referred to as a load control device) such as a triac or relay is shorted. In this case, the microcomputer detects the shorted power output control device, but is unable to shut off the product due to the shorted power output control device which continues to drive the appliance through the short circuit.

What is desired is an inexpensive way for a microcomputer to disable a product if it determines that the power output device is shorted. Adding redundant relays or triacs in series with the primary power output device allows the microcomputer to disable the product in case of a shorted power output device. However, such components are often exposed to the same condition which caused the primary power output control device to fail and hence this condition damages the redundant devices, resulting in an inability to turn off the appliance.

### SUMMARY OF THE INVENTION

The present invention is directed to a power circuit for a small appliance wherein a thermal fuse is placed in series with the power supplied to a power output control device. One or more resistors are placed in close proximity to the thermal fuse. The resistor or resistors are electrically connected to a transistor that is controlled by a microcomputer or microprocessor. The transistor is normally off, preventing power from being applied to the resistor(s).

If a shorted power output control device is detected by the microcomputer, the microcomputer turns on the transistor to apply power to the resistor(s). The area around the resistor(s) increases in temperature due to the heat produced by the resistors. Within a specified predetermined period, the area around the resistor(s) increases in temperature sufficiently such that the heat from the resistor(s) exceeds the temperature rating of the thermal fuse. This causes the thermal fuse to open, removing all power from the appliance in spite of the short circuited power output control device. In this manner, the microcomputer or microprocessor disables the product upon detection of a shorted power output control device.

Further features and advantages of the present invention will become more apparent to those skilled in the art after a review of the invention as it shown in the accompanying drawings and detailed description.

### BRIEF DESCRIPTION OF THE DRAWINGS

FIG. 1 is a representative control circuit constructed in accordance with the present invention.

### DETAILED DESCRIPTION OF THE DRAWINGS

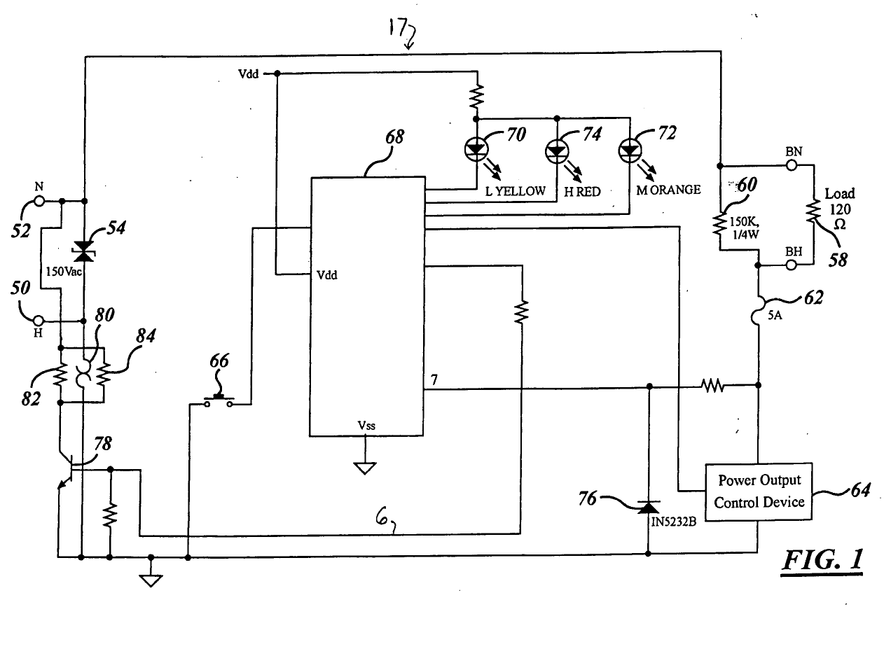

As shown in FIG. 1, a circuit 17 is constructed in accordance with the present invention to provide power to a load such as a household electrical appliance such as a heating blanket, toaster, steam iron, etc. The circuit 17 has two power input terminals 50 and 52 to connect to an AC power input such as a household wall socket outlet. A 150 volt AC MOV diode 54 acts as a surge protector. Heater wires such as those used in an electric blanket provide a 120 ohm electrical load 58. The electrical load 58 is arranged in a parallel circuit with 150 K ohm resistor 60. A 5 amp fuse 62 is provided to protect the circuit 17 against short circuits in the heater wires 58 of the blanket or other appliance. The electrical load 58 is controlled by a power output control device 64. The power output control device 64 can be a triac, a pair of SCRs (silicon controlled rectifier), or a relay.

A manually operated switch 66 is provided to operate a microcomputer 68. For purposes of the present description, the term “microcomputer” is used to describe a microcomputer, microcontroller, or a microprocessor used in combination with other components to provide microcomputer-type functionality. In the example shown in FIG. 1, the microcomputer 68 is a ST Microelectronics ST6215C microcomputer.

A single tap or push on the switch 66 activates the microcomputer 68 to signal the power output control device 64 to provide, for example, a one-fourth power level to load wires 58. A yellow diode 70 is lit to indicate a low power setting such as a 25% power setting. A second tap or push on the switch 66 activates the microcomputer 68 to signal the power output control device 64 to provide, for example, a one-half power level to load 58 and to light an orange diode 72 indicating, for example, a 50% power setting. A third tap or push on the switch 66 activates the microcomputer 68 to signal the power output control device 64 to provide a full power level to load 58 and to light a red diode 74 to indicate, for example, a full power setting. A fourth tap or push on the switch 66 activates the microcomputer 68 to signal the power output control device 64 to turn off all power to load 58.

Operation of the power output control device 64 is monitored by the microcomputer 68 via signal input line 7. The line 7 is connected in a parallel circuit with a 5 volt zener diode 76. When the power output control device 64 is on, the voltage on line 7 is set at less than 2 volts. When the power output control device 64 is off, the voltage on line 7 is clamped at 5 volts by the zener diode 76.

If the power output control device 64 fails due to a short circuit condition (usually caused by a voltage spike caused by lightning or electrical noise generated by the use of another electric appliance in the home), the microcomputer 68 will detect a zero voltage condition on line 7. In response, the microcomputer 68, via output line 6, turns on the transistor 78.

Located in series with the power to the load 58 is a thermal fuse 80. Located thermally proximate to the fuse 80 are two resistors 82 and 84. The resistors 82 and 84 may have the same resistance (in the example shown 10K ohm) or may differ so that one resistor may supply more heat to the fuse 80 if desired. The resistors 82 and 84 are electrically connected with a switching device such as provided by the transistor 78. The transistor 78 is normally off.

In operation, the power output control device 64 controls the amount of power supplied the load 58. If a failure (short) condition in the power output control device 64 occurs, it will be detected by the microcomputer 68 via input line 7. The microcomputer 68 will, in response, turn on or apply power to the transistor 78. This activation of the transistor 78 causes current to flow through the resistors 82 and 84 and cause them to heat up. After a specified period, the temperature rating of the fuse 80 is exceeded by the heat produced by the resistors 82 and 84, thereby causing the fuse 80 to open or blow so as to cut off and remove power to the load 58.

While preferred embodiments of the present invention have been disclosed, it is to be understood that they have been disclosed by way of example only and that various modifications can be made without departing from the spirit and scope of the invention as it is explained by the following claims.

1. A circuit for powering an electrical appliance load, comprising:
a power output control device to supply power to said load;
a thermal fuse in series with said power output control device;
a resistor device in thermal proximity to said thermal fuse;
a switching device to turn on said resistor device; and
a microcomputer controller for monitoring a short fault condition of said power output control device, said microcomputer controller turning on said switching device upon detecting a short fault condition in said power output control device.

2. A circuit as described in claim 1 wherein said power output control device comprises a triac.

3. A circuit as described in claim 1 wherein said power output control device comprises a relay.

4. A circuit as described in claim 1 wherein said power output control device comprises a pair of SCRs.

5. A circuit as described in claim 1 further comprising a plurality of resistor devices in thermal proximity to said thermal fuse.

6. A circuit as described in claim 1 wherein said switching device comprises a transistor.

7. A circuit as described in claim 1 further comprising a current fuse in series with said power output control device to turn off current to said power output control device due to a short in said load.

8. A circuit for powering an electrical appliance load, comprising:
a triac to supply power to said load;
a current fuse in series with said triac to turn off current to said triac due to a short in said load;
a thermal fuse in series with said triac;
a resistor in thermal proximity to said thermal fuse;
a transistor to turn on said resistor; and
a microcomputer controller for monitoring a short fault condition of said triac, said microcomputer controller turning on said transistor upon detecting a short fault condition in said triac.

9. A method of powering a small electrical appliance load comprising:
powering said load with a power output control device;
connecting in series with said power output control device a thermal fuse;
providing a resistor device in thermal proximity to said thermal fuse;
determining a short fault condition of said output controlling device;
switching on said resistor device; and
heating said resistor device to open said thermal fuse.

10. A method as described in claim 9 further including providing a plurality of resistor devices in thermal proximity to said thermal fuse.

11. A method as described in claim 9 further including turning off current to said output control device due to a short in said load with a current fuse in series with said power output control device.
